(19) United States
(12) Patent Application Publication
(10) Pub. No.: US 2017/0300486 A1
(43) Pub. Date: Oct. 19, 2017

(54) SYSTEM AND METHOD FOR COMPATABILITY-BASED CLUSTERING OF MULTIMEDIA CONTENT ELEMENTS

(71) Applicant: Cortica, Ltd., TEL AVIV (IL)

(72) Inventors: Igal Raichelgauz, Tel Aviv (IL); Karina Odinaev, Tel Aviv (IL); Yehoshua Y. Zeevi, Haifa (IL)

(73) Assignee: Cortica, Ltd., TEL AVIV (IL)

(21) Appl. No.: 15/637,674

(22) Filed: Jun. 29, 2017

Related U.S. Application Data
(63) Continuation-in-part of application No. 15/420,989, filed on Jan. 31, 2017.
Application No. 15/420,989 is a continuation-in-part of application No. 14/509,558, filed on Oct. 8, 2014, now Pat. No. 9,575,969.
Application No. 14/509,558 is a continuation of application No. 13/602,858, filed on Sep. 4, 2012, now Pat. No. 8,868,619.
Application No. 13/602,858 is a continuation of application No. 12/603,123, filed on Oct. 21, 2009, now Pat. No. 8,266,185.
Application No. 12/603,123 is a continuation-in-part of application No. 12/084,150, filed on Apr. 7, 2009, now Pat. No. 8,655,801.
Application No. 12/603,123 is a continuation-in-part of application No. 12/195,863, filed on Aug. 21, 2008, now Pat. No. 8,326,775.
Application No. 12/195,863 is a continuation-in-part of application No. 12/084,150, filed on Apr. 7, 2009, now Pat. No. 8,655,801.
Application No. 12/603,123 is a continuation-in-part of application No. 12/348,888, filed on Jan. 5, 2009.
Application No. 12/348,888 is a continuation-in-part of application No. 12/084,150, filed on Apr. 7, 2009, now Pat. No. 8,655,801.
Application No. 12/084,150 is a continuation-in-part of application No. 12/195,863, filed on Aug. 21, 2008, now Pat. No. 8,326,775.
Application No. 12/603,123 is a continuation-in-part of application No. 12/538,495, filed on Aug. 10, 2009, now Pat. No. 8,312,031.
Application No. 12/538,495 is a continuation-in-part of application No. 12/084,150, filed on Apr. 7, 2009, now Pat. No. 8,655,801.
Application No. 12/084,150 is a continuation-in-part of application No. 12/195,863, filed on Aug. 21, 2008, now Pat. No. 8,326,775.
Application No. 12/195,863 is a continuation-in-part of application No. 12/348,888, filed on Jan. 5, 2009.
(60) Provisional application No. 62/358,008, filed on Jul. 3, 2016.
(60) Provisional application No. 62/307,515, filed on Mar. 13, 2016.

(30) Foreign Application Priority Data
Oct. 26, 2005 (IL) 171577
Jan. 29, 2006 (IL) 173409
Aug. 21, 2007 (IL) 185414

(51) Int. Cl. G06F 17/30

(52) U.S. Cl. CPC G06F 17/30017; G06F 17/30867

(57) ABSTRACT

A system and method for compatibility-based clustering of multimedia content elements. The method includes generating at least one signature for the multimedia content element; analyzing, by at least one compatibility engine, the generated at least one signature to determine at least one compatibility score, wherein each compatibility engine is associated with at least one cluster of multimedia content elements, wherein each compatibility engine is configured to compare the generated at least one signature to signatures of the associated at least one cluster, wherein the at least one compatibility score is determined based on the comparison; determining, based on the at least one compatibility score, at least one compatible cluster; and adding, to each compatible cluster, the multimedia content element.

### CROSS-REFERENCE TO RELATED APPLICATIONS

This application claims the benefit of U.S. Provisional Application No. 62/358,008 filed on Jul. 3, 2016. This application is also a continuation-in-part (CIP) of U.S. patent application Ser. No. 15/420,989 filed on Jan. 31, 2017, now pending, which claims the benefit of U.S. Provisional Application No. 62/307,515 filed on Mar. 13, 2016. The Ser. No. 15/420,989 application is also a CIP of U.S. patent application Ser. No. 14/509,558 filed on Oct. 8, 2014, now U.S. Pat. No. 9,575,969, which is a continuation of U.S. patent application Ser. No. 13/602,858 filed on Sep. 4, 2012, now U.S. Pat. No. 8,868,619. The Ser. No. 13/602,858 application is a continuation of U.S. patent application Ser. No. 12/603,123 filed on Oct. 21, 2009, now U.S. Pat. No. 8,266,185. The Ser. No. 12/603,123 application is a continuation-in-part of:

(1) U.S. patent application Ser. No. 12/084,150 having a filing date of Apr. 7, 2009, now U.S. Pat. No. 8,655,801, which is the National Stage of International Application No. PCT/IL2006/001235 filed on Oct. 26, 2006, which claims foreign priority from Israeli Application No. 171577 filed on Oct. 26, 2005, and Israeli Application No. 173409 filed on Jan. 29, 2006;

(2) U.S. patent application Ser. No. 12/195,863 filed on Aug. 21, 2008, now U.S. Pat. No. 8,326,775, which claims priority under 35 USC 119 from Israeli Application No. 185414 filed on Aug. 21, 2007, and which is also a continuation-in-part of the above-referenced U.S. patent application Ser. No. 12/084,150;

(3) U.S. patent application Ser. No. 12/348,888, filed Jan. 5, 2009, now pending, which is a CIP of the above-referenced U.S. patent application Ser. No. 12/084,150 and the above-referenced U.S. patent application Ser. No. 12/195,863; and

(4) U.S. patent application Ser. No. 12/538,495, filed Aug. 10, 2009, now U.S. Pat. No. 8,312,031, which is a CIP of the above-referenced U.S. patent application Ser. No. 12/084,150; the above-referenced U.S. patent application Ser. No. 12/195,863; and the above-referenced U.S. patent application Ser. No. 12/348,888.

The contents of the above-referenced applications are hereby incorporated by reference.

### TECHNICAL FIELD

The present disclosure relates generally to organizing multimedia content, and more specifically to clustering based on compatibility of multimedia content elements with clusters of multimedia content elements.

### BACKGROUND

As the Internet continues to grow exponentially in size and content, the task of finding relevant and appropriate information has become increasingly complex. Organized information can be browsed or searched more quickly than unorganized information. As a result, effective organization of content allowing for subsequent retrieval is becoming increasingly important.

Search engines are often used to search for information, either locally or over the World Wide Web. Many search engines receive queries from users and uses such queries to find and return relevant content. The search queries may be in the form of, for example, textual queries, images, audio queries, etc.

Search engines often face challenges when searching for multimedia content (e.g., images, audio, videos, etc.). In particular, existing solutions for searching for multimedia content are typically based on metadata of multimedia content elements. Such metadata may be associated with a multimedia content element and may include parameters such as, for example, size, type, name, short description, tags describing articles or subject matter of the multimedia content element, and the like. A tag is a non-hierarchical keyword or term assigned to data (e.g., multimedia content elements). The name, tags, and short description are typically manually provided by, e.g., the creator of the multimedia content element (for example, a user who captured the image using his smart phone), a person storing the multimedia content element in a storage, and the like.

Further, because at least some of the metadata of a multimedia content element is typically provided manually by a user, such metadata may not accurately describe the multimedia content element or facets thereof. As examples, the metadata may be misspelled, provided with respect to a different image than intended, vague or otherwise failing to identify one or more aspects of the multimedia content, and the like. As an example, a user may provide a file name “weekend fun” for an image of a cat, which does not accurately indicate the contents (e.g., the cat) shown in the image. Thus, a query for the term “cat” would not return the “weekend fun” image.

Existing solutions for grouping multimedia content elements include grouping the multimedia content elements based on content indicated in the metadata of the multimedia content element. Thus, although solutions for grouping multimedia content elements based on content exist, such solutions may be inaccurate. It would be advantageous to provide a solution for more accurately automatically grouping multimedia content elements.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” may be used herein to refer to a single embodiment or multiple embodiments of the disclosure.

Some embodiments disclosed herein include a method for compatibility-based clustering of multimedia content elements. The method comprises: generating at least one signature for the multimedia content element; analyzing, by at least one compatibility engine, the generated at least one signature to determine at least one compatibility score, wherein each compatibility engine is associated with at least one cluster of multimedia content elements, wherein each compatibility engine is configured to compare the generated at least one signature to signatures of the associated at least one cluster, wherein the at least one compatibility score is determined based on the comparison; determining, based on the at least one compatibility score, at least one compatible cluster; and adding, to each compatible cluster, the multimedia content element.

Some embodiments disclosed herein also include a non-transitory computer readable medium having stored thereon instructions for causing a processing circuitry to execute a process, the process comprising: generating at least one signature for the multimedia content element; analyzing, by at least one compatibility engine, the generated at least one signature to determine at least one compatibility score, wherein each compatibility engine is associated with at least one cluster of multimedia content elements, wherein each compatibility engine is configured to compare the generated at least one signature to signatures of the associated at least one cluster, wherein the at least one compatibility score is determined based on the comparison; determining, based on the at least one compatibility score, at least one compatible cluster; and adding, to each compatible cluster, the multimedia content element.

Some embodiments disclosed herein also include a system for compatibility-based clustering of multimedia content elements. The system comprises a processing circuitry; and a memory, the memory containing instructions that, when executed by the processing circuitry, configure the system to: generate at least one signature for the multimedia content element; analyze, by at least one compatibility engine, the generated at least one signature to determine at least one compatibility score, wherein each compatibility engine is associated with at least one cluster of multimedia content elements, wherein each compatibility engine is configured to compare the generated at least one signature to signatures of the associated at least one cluster, wherein the at least one compatibility score is determined based on the comparison; determine, based on the at least one compatibility score, at least one compatible cluster; and add, to each compatible cluster, the multimedia content element.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe the various disclosed embodiments.

FIG. 2 is a flowchart illustrating a method for compatibility-based clustering of multimedia content elements according to an embodiment.

FIG. 3 is a block diagram depicting the basic flow of information in the signature generator system.

FIG. 4 is a diagram showing the flow of patches generation, response vector generation, and signature generation in a large-scale speech-to-text system.

FIG. 5 is a block diagram illustrating a clustering system according to an embodiment.

FIG. 6 is a simulation illustrating example compatibility engines utilized for clustering multimedia content elements.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method and system for compatibility-based clustering of multimedia content elements (MMCEs). The clustering allows for organizing and searching of multimedia content elements based on common concepts. In an example embodiment, an input multimedia content element to be clustered is obtained. Signatures are generated for the input multimedia content element. Each signature represents a concept. The signatures may be generated based on the input multimedia content element, metadata of the input multimedia content element, or both.

The signatures are sent to a plurality of compatibility engines. Each compatibility engine is associated with one or more clusters of multimedia content elements and is configured to analyze signatures to determine a compatibility score of each associated cluster with respect to the input multimedia content element. Each cluster includes a plurality of multimedia content elements having at least one concept in common. Based on the compatibility scores, at least one compatible cluster is determined. The multimedia content element is added to each compatible cluster. In some implementations, compatibility scores for a cluster from two or more related compatibility engines may be aggregated to determine an aggregate compatibility score for the cluster with respect to the input multimedia content element.

In an example implementation, the common concept among multimedia content elements of a cluster may be a collection of signatures representing elements of the unstructured data and metadata describing the concept. The common concept may represent an item or aspect of the multimedia content elements such as, but not limited to, an object, a person, an animal, a pattern, a color, a background, a character, a sub textual aspect (e.g., an aspect indicating sub textual information such as activities or actions being performed, relationships among individuals shown such as teams or members of an organization, etc.), a meta aspect indicating information about the multimedia content element itself (e.g., an aspect indicating that an image is a “selfie” taken by a person in the image), words, sounds, voices, motions, combinations thereof, and the like. As non-limiting examples, the common concept may represent, e.g., a Labrador retriever dog shown in images or videos, a voice of the actor Daniel Radcliffe that can be heard in audio or videos, a motion including swinging of a baseball bat shown in videos, a subtext of playing chess, an indication that an image is a “selfie,” and the like.

Clustering multimedia content elements based on signatures generated as described herein allows for increased accuracy of clustering as compared to, for example, clustering based on matching metadata alone. Providing the generated signatures to compatibility engines configured with different clusters further increases accuracy of clustering by comparing the generated signatures to focused groupings of multimedia content element signatures representing different categories of content. Additionally, techniques for improving efficiency of the signature-based clustering are disclosed.

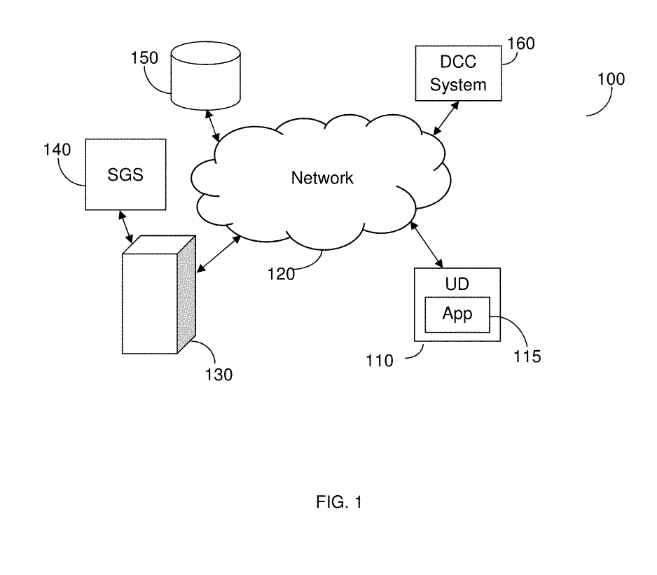

FIG. 1 shows an example network diagram 100 utilized to describe the various disclosed embodiments. The example network diagram includes a user device 110, a compatibility-based clustering system 130 (hereinafter referred to as the “clustering system 130,” merely for simplicity purposes), a database 150, and a deep content classification (DCC) system 160, communicatively connected via a network 120.

The network 120 is used to communicate between different components of the network diagram 100. The network 120 may be the Internet, the world-wide-web (WWW), a local area network (LAN), a wide area network (WAN), a metro area network (MAN), and other networks capable of enabling communication between the components of the network diagram 100.

The user device 110 may be, but is not limited to, a personal computer (PC), a personal digital assistant (PDA), a mobile phone, a smart phone, a tablet computer, a wearable computing device, a smart television, and other devices configured for storing, viewing, and sending multimedia content elements.

The user device 110 may have installed thereon an application (app) 115. The application 115 may be downloaded from applications repositories such as, but not limited to, the AppStore®, Google Play®, or any other repositories storing applications. The application 115 may be pre-installed in the user device 110. The application 115 may be, but is not limited to, a mobile application, a virtual application, a web application, a native application, and the like. In some embodiments, the app 115 may be configured to perform compatibility-based clustering of multimedia content elements, as described herein.

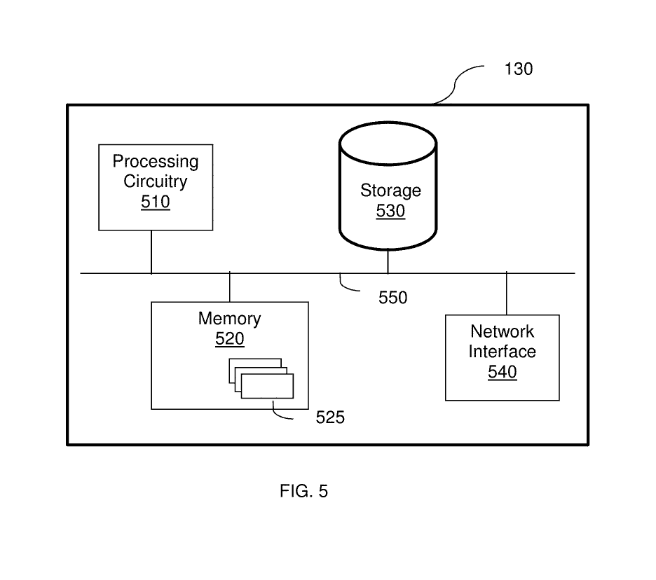

In an embodiment, the clustering system 130 is configured to cluster multimedia content elements. The clustering system 130 typically includes, but is not limited to, a processing circuitry connected to a memory (not shown), the memory containing instructions that, when executed by the processing circuitry, configure the clustering system 130 to at least perform clustering of multimedia content elements as described herein. In an embodiment, the processing circuitry may be realized as an array of at least partially statistically independent computational core, the properties of each core being set independently of the properties of each other core. An example block diagram of the clustering system 130 is described further herein below with respect to FIG. 5.

In an embodiment, the clustering system 130 is configured to initiate clustering of an input multimedia content element upon detection of a clustering trigger event. The clustering trigger event may include, but is not limited to, receipt of a request to cluster one or more multimedia content elements.

To this end, the clustering system 130 may be configured to receive, from the user device 110, a request to cluster an input multimedia content element. Clustering the input multimedia content element may include adding the input multimedia content element to a compatible cluster as described herein. The request may include, but is not limited to, the input multimedia content element, an identifier of the input multimedia content element, an indicator of a location of the input multimedia content element (e.g., an indicator of a location in the database 150 in which the multimedia content elements are stored), a combination thereof, and the like. As non-limiting examples, the request may include an input image, an identifier used for finding the image, a location of the image in a storage (e.g., one of the data sources 160 ), or a combination thereof.

The multimedia content elements may include, but are not limited to, images, graphics, video streams, video clips, audio streams, audio clips, video frames, photographs, images of signals (e.g., spectrograms, phasograms, scalograms, etc.), combinations thereof, portions thereof, and the like. The multimedia content elements may be, e.g., captured via the user device 110.

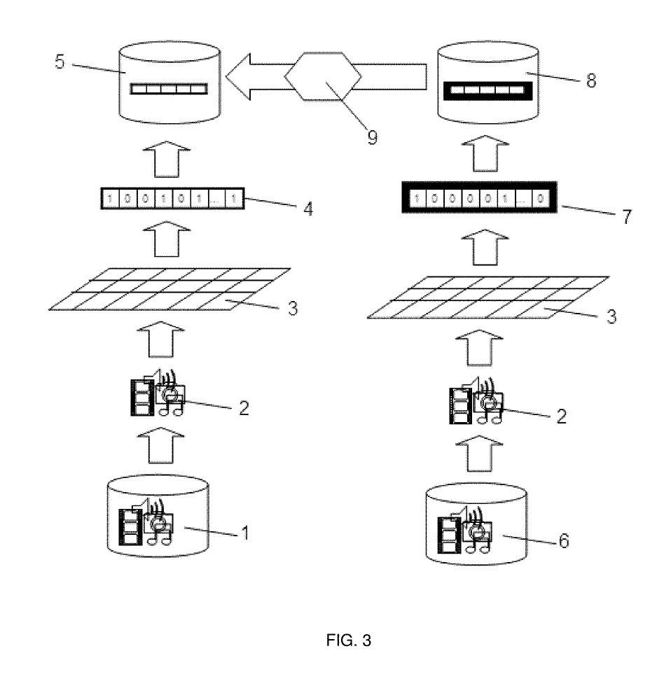

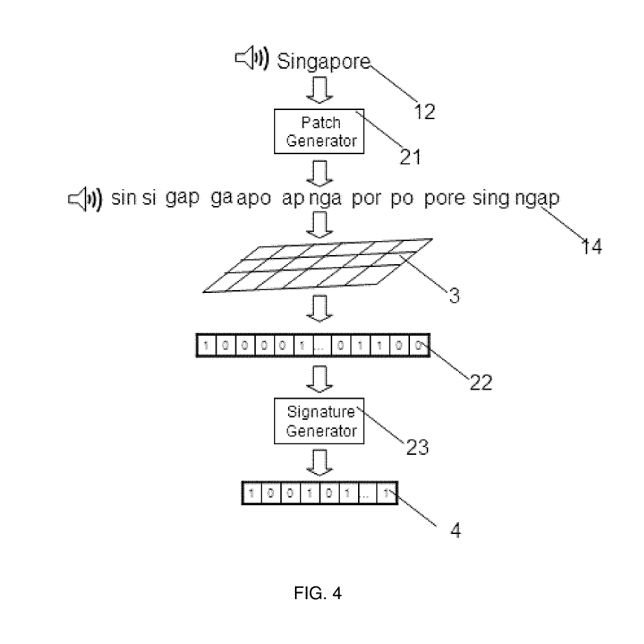

The clustering system 130 may be further communicatively connected to a signature generator system (SGS) 140. The clustering system 130 may be configured to send, to the signature generator system 140, each input multimedia content element. The signature generator system 140 is configured to generate signatures based on the input multimedia content element and to send the generated signatures to the clustering system 130. Alternatively, the clustering system 130 may be configured to generate the signatures. Generation of signatures based on multimedia content elements is described further herein below with respect to FIGS. 3 and 4.

The clustering system 130 may also be communicatively connected to a deep-content classification (DCC) system 160. The DCC system 160 may be configured to continuously create a knowledge database for multimedia data. To this end, the DCC system 160 may be configured to initially receive a large number of multimedia content elements to create a knowledge database that is condensed into concept structures that are efficient to store, retrieve, and check for matches. As new multimedia content elements are collected by the DCC system 160, they are efficiently added to the knowledge base and concept structures such that the resource requirement is generally sub-linear rather than linear or exponential. The DCC system 160 is configured to extract patterns from each multimedia content element and selects the important/salient patterns for the creation of signatures thereof. A process of inter-matching between the patterns followed by clustering, is followed by reduction of the number of signatures in a cluster to a minimum that maintains matching and enables generalization to new multimedia content elements. Metadata respective of the multimedia content elements is collected, thereby forming, together with the reduced clusters, a concept structure.

The clustering system 130 may be configured to obtain, from the DCC system 160, at least one concept structure matching the input multimedia content element. Further, the clustering system 130 may be configured to query the DCC system 160 for the matching concept structures. The query may be made with respect to the signatures for the multimedia content elements to be clustered. Multimedia content elements associated with the obtained matching concept structures may be utilized for determining compatible clusters to which the input multimedia content element is added.

In an embodiment, based on the generated signatures, the clustering system 130 is configured to determine at least one compatible cluster to which the input multimedia content element should be added. Each compatible cluster includes a plurality of multimedia content elements sharing at least one common concept. The common concept among multimedia content elements may be a collection of signatures representing elements of the unstructured data and metadata describing the concept. The common concept may represent an item or aspect of the multimedia content elements such as, but not limited to, an object, a person, an animal, a pattern, a color, a background, a character, a sub textual aspect, a meta aspect, words, sounds, voices, motions, combinations thereof, and the like. Multimedia content elements may share a common concept when each of the multimedia content elements is associated with at least one signature or portion thereof that is common to the multimedia content elements sharing a common concept.

It should be noted that multiple compatible clusters may be determined for the input multimedia content element. As a non-limiting example, for an image showing a “selfie” of a person (i.e., an image showing the person that is captured by the person) taken on the beach, clusters including multimedia content elements showing the person, selfies of the person or of other people, and beach scenery may be determined as compatible, and the selfie image may be clustered into each of the compatible clusters.

In an embodiment, determining the compatible clusters further includes providing the generated signatures to compatibility engines (e.g., the compatibility engines 525, FIG. 5). Each compatibility engine may be a software module installed on the clustering system 130 and is associated with one or more clusters of multimedia content elements. Each compatibility engine is configured to analyze signatures of an input multimedia content element to determine a compatibility of the input multimedia content element with the associated clusters. To this end, each compatibility engine is configured with signatures representing concepts of the associated clusters.

Each compatibility engine is configured to compare the signatures of the input multimedia content element to the signatures of the associated clusters and to determine, based on the comparison, a compatibility score for each cluster with respect to the input multimedia content element. Each compatibility score represents a degree of certainty that the input multimedia content element is compatible with the respective cluster. A cluster may be a compatible cluster for the multimedia content element when, for example, the compatibility score generated for the cluster is above a predetermined threshold.

In some implementations, two or more of the compatibility engines may be at least partially related with respect to clusters that are common to all of the related compatibility engines. As a non-limiting example, a food engine may be related to a party engine in that one or more clusters of multimedia content elements showing food are commonly associated with both the food engine and the party engine (e.g., clusters showing parties in which food was served).

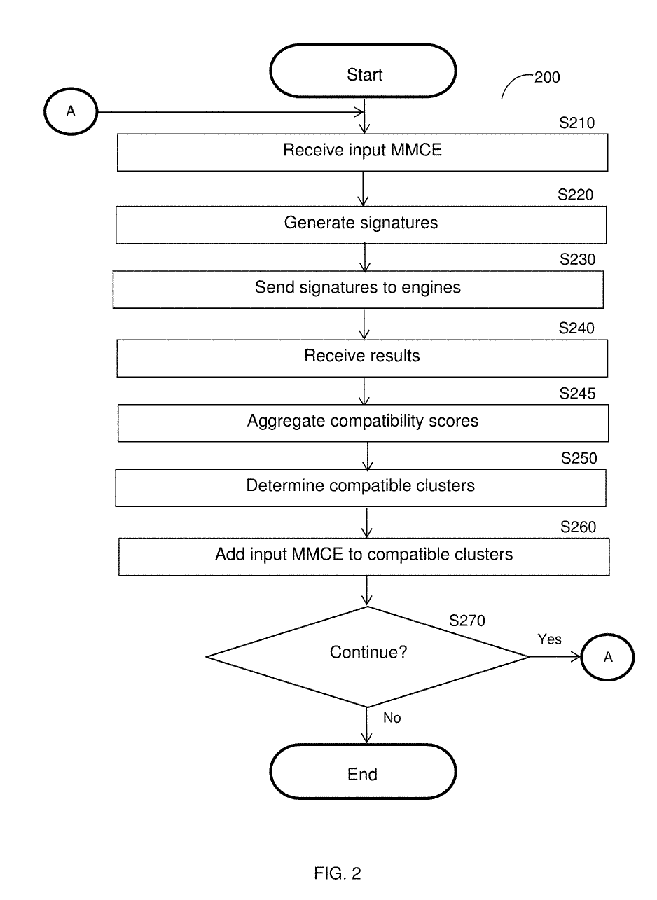

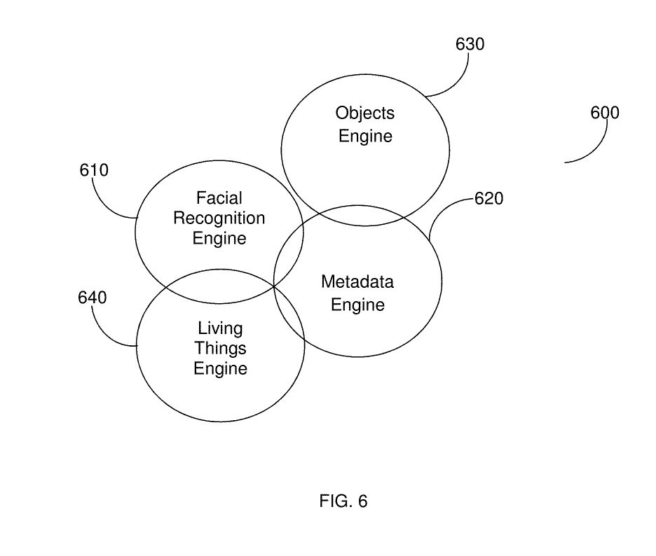

Compatibility scores from related engines may be aggregated to determine an aggregated compatibility score for each commonly associated cluster. Also, results of analysis by one compatibility engine may be utilized to assist in efficiently determining compatible clusters. For example, if one compatibility engine returns a high compatibility score, analysis by one or more of the other compatibility engines may not be needed. Aggregating compatibility scores and assisting efficient determinations are described further herein below with respect to FIGS. 2 and 6.

It should be noted that using signatures for clustering multimedia content elements ensures more accurate clustering of multimedia content than, for example, when using metadata alone (e.g., tags provided by users). For instance, in order to cluster an image of a sports car into an appropriate cluster, it may be desirable to locate a car of a particular model. However, in most cases the model of the car would not be part of the metadata associated with the multimedia content (image). Moreover, the car shown in an image may be at angles different from the angles of a specific photograph of the car that is available as a search item. The signature generated for that image would enable accurate recognition of the model of the car because the signatures generated for the multimedia content elements, according to the disclosed embodiments, allow for recognition and classification of multimedia content elements, such as, content-tracking, video filtering, multimedia taxonomy generation, video fingerprinting, speech-to-text, audio classification, element recognition, video/image search and any other application requiring content-based signatures generation and matching for large content volumes such as, web and other large-scale databases.

The database 150 stores clusters of multimedia content elements associated with each compatibility engine. In the example network diagram 100 shown in FIG. 1, the clustering system 130 communicates with the database 150 through the network 120. In other non-limiting configurations, the clustering system 130 may be directly connected to the database 150. The database 150 may be accessible to, e.g., the user device 110, other user devices (not shown), or both, thereby allowing for retrieval of clusters from the database 150 by such user devices.

It should also be noted that the signature generator system 140 and the DCC system 160 are shown in FIG. 1 as being directly connected to the clustering system 130 merely for simplicity purposes and without limitation on the disclosed embodiments. The signature generator system 140, the DCC system 160, or both, may be included in the clustering system 130 or communicatively connected to the clustering system 130 over, e.g., the network 120, without departing from the scope of the disclosure.

It should be further noted that the clustering is described as being performed by the clustering system 130 merely for simplicity purposes and without limitation on the disclosed embodiments. The clustering may be equally performed locally by, e.g., the user device 110, without departing from the scope of the disclosure. In such a case, the user device 110 may include the clustering system 130, the signature generator system 140, the DCC system 160, or any combination thereof, or may otherwise be configured to perform any or all of the processes performed by such systems. For example, the app 115 may be include the compatibility engines and may be configured to determine compatible clusters using the compatibility engines.

As a non-limiting example for local clustering by the user device 110, the clustering may be based on clusters of images in a photo library stored on the user device 110 such that new images may be clustered in real-time and, therefore, subsequently searched by a user of the user device 110. Thus, when, for example, the user of the user device 110 captures an image of his dog named “Lucky,” the user device 110 may cluster the image with other images of the dog Lucky stored in the user device 110 such that, when the user searches through the user device 110 for images using the query “lucky,” the captured image is returned along with other clustered images of the dog Lucky.

FIG. 2 is an example flowchart 200 illustrating a method for compatibility-based clustering of multimedia content elements according to an embodiment. In an embodiment, the method may be performed by the clustering system 130 or the user device 110, FIG. 1.

At S210, an input multimedia content element (MMCE) to be clustered is received or retrieved. In an embodiment, the multimedia content element may be obtained based on a request to cluster the input multimedia content element. The request may include the input multimedia content element, an identifier of the input multimedia content element, an indicator of a location of the input multimedia content element, and the like.

At S220, signatures are generated for the input multimedia content element. Each generated signature may be robust to noise and distortion. In an embodiment, the signatures are generated by a signature generator system as described further herein below with respect to FIGS. 3 and 4. Further, S220 may include sending, to a signature generator system (e.g., the signature generator system 140, FIG. 1), the multimedia content element and receiving, from the signature generator system, the signatures generated for each multimedia content element. Alternatively, S220 may include sending, to a deep content classification (DCC) system (e.g., the DCC system 160, FIG. 1) the input multimedia content element and receiving, from the DCC system, signatures representing one or more matching concepts. The signatures allow for accurate recognition and classification of multimedia content elements.

At S230, the generated signatures are sent to one or more compatibility engines for analysis. Each compatibility engine is associated with one or more clusters of multimedia content elements and is configured with signatures representing the associated clusters. Each cluster includes a plurality of multimedia content elements sharing a common concept as described further herein above.

Each compatibility engine is configured to receive and analyze signatures of an input multimedia content element to determine compatibility of each associated cluster with respect to the input multimedia content element. Specifically, each compatibility engine may be configured to compare the signatures of the input multimedia content element to signatures of each associated cluster and to determine, based on the comparison, a compatibility score for each associated cluster. In some implementations, S230 may include configuring and initializing the compatibility engines to analyze the generated signatures. Example compatibility engines are described further herein below with respect to FIG. 6.

In another implementation, results from one compatibility engine may be utilized to assist in more efficiently determining compatibility. To this end, S230 may include determining, based on a compatibility score determine for one of the compatibility engines, whether one or more of the other compatibility engines should not be configured or initialized to analyze the generated signatures. For example, if a living things engine returns a compatibility score for a cluster above a predetermined threshold, an objects engine (i.e., an engine representing non-living things) may not be initialized. As another example, if a metadata engine returns a compatibility score for a cluster above a predetermined threshold, no other engines may be initialized. Selectively utilizing compatibility engines allows for conservation of computing resources, as engines that are redundant or otherwise not needed to determine compatible clusters are not used.

At S240, results of the analyses are received from the engines. The results include at least one compatibility score determined for each cluster with respect to the input multimedia content element.

At optional S245, an aggregated compatibility score may be determined for each cluster having compatibility scores that were determined by two or more related engines. Each aggregated compatibility score may be utilized as the compatibility score for the respective cluster. The aggregation may further include determining a weighted average for the compatibility scores of the cluster. The weights may be predetermined weights representing relative certainties that a high compatibility score determined by the respective compatibility engine accurately reflects compatibility with a cluster. For example, for a cluster of multimedia content elements showing dogs associated with a dogs engine and a pets engine, a weight applied to a compatibility score determined by the dogs engine may be 0.8, while a weight applied to a compatibility score determined by the pets engine may be 0.2, as high compatibility determined by the dogs engine is more likely to accurately illustrate compatibility of the cluster than that of the pets engine.

A set of engines may be related when each engine of the set is associated with a common cluster. For example, a pets engine associated with pets clusters showing various types of pets may be related to a dogs engine associated with dogs clusters showing various types of dogs in that at least some of the pets clusters showing dogs are also among the dogs clusters.

At S250, at least one compatible cluster is determined based on the received results. In an embodiment, each compatible cluster has a compatibility score above a predetermined threshold.

At S260, the input multimedia content element is added to each compatible cluster. In an embodiment, S260 may further include storing each compatible cluster with the added input multimedia content element in a storage (e.g., the database 150 of FIG. 1, a data source such as a web server, etc.). As a non-limiting example, the cluster may be stored in a server of a social media platform, thereby enabling other users to find the cluster during searches. Each cluster may be stored separately such that different groupings of multimedia content elements are stored in separate locations. For example, different clusters of multimedia content elements may be stored in different folders.

At S270, it is determined if additional multimedia content elements are to be clustered and, if so, execution continues with S210; otherwise, execution terminates.

Clustering of the input multimedia content element allows for organizing the input multimedia content element based on subject matter represented by various concepts. Such organization may be useful for, e.g., organizing photos captured by a user of a smart phone based on common subject matter. As a non-limiting example, images showing dogs, a football game, and food may be organized into different collections and, for example, stored in separate folders on the smart phone. Such organization may be particularly useful for social media or other content sharing applications, as multimedia content being shared can be organized and shared with respect to content. Additionally, such organization may be useful for subsequent retrieval, particularly when the organization is based on tags. As noted above, using signatures to classify the input multimedia content elements typically results in more accurate identification of multimedia content elements sharing similar content.

It should be noted that the embodiments described herein above with respect to FIG. 2 are discussed as including clustering input multimedia content elements in series merely for simplicity purposes and without limitations on the disclosure. Multiple input multimedia content elements may be clustered in parallel without departing from the scope of the disclosure. Further, the clustering method discussed above can be performed by the clustering system 130, or locally by a user device (e.g., the user device 110, FIG. 1). For example, the app 115 may be configured to perform the clustering as described herein.

FIGS. 3 and 4 illustrate the generation of signatures for the multimedia content elements by the signature generator system 140 according to an embodiment. An example high-level description of the process for large scale matching is depicted in FIG. 3. In this example, the matching is for a video content.

Video content segments 2 from a Master database (DB) 6 and a Target DB 1 are processed in parallel by a large number of independent computational Cores 3 that constitute an architecture for generating the Signatures (hereinafter the “Architecture”). Further details on the computational Cores generation are provided below. The independent Cores 3 generate a database of Robust Signatures and Signatures 4 for Target content-segments 5 and a database of Robust Signatures and Signatures 7 for Master content-segments 8. An exemplary and non-limiting process of signature generation for an audio component is shown in detail in FIG. 4. Finally, Target Robust Signatures and/or Signatures are effectively matched, by a matching algorithm 9, to Master Robust Signatures and/or Signatures database to find all matches between the two databases.

To demonstrate an example of the signature generation process, it is assumed, merely for the sake of simplicity and without limitation on the generality of the disclosed embodiments, that the signatures are based on a single frame, leading to certain simplification of the computational cores generation. The Matching System is extensible for signatures generation capturing the dynamics in-between the frames.

The Signatures' generation process is now described with reference to FIG. 4. The first step in the process of signatures generation from a given speech-segment is to breakdown the speech-segment to K patches 14 of random length P and random position within the speech segment 12. The breakdown is performed by the patch generator component 21. The value of the number of patches K, random length P and random position parameters is determined based on optimization, considering the tradeoff between accuracy rate and the number of fast matches required in the flow process of the context server 130 and SGS 140. Thereafter, all the K patches are injected in parallel into all computational Cores 3 to generate K response vectors 22, which are fed into a signature generator system 23 to produce a database of Robust Signatures and Signatures 4.

In order to generate Robust Signatures, i.e., Signatures that are robust to additive noise L (where L is an integer equal to or greater than 1) by the Computational Cores 3 a frame ‘i’ is injected into all the Cores 3. Then, Cores 3 generate two binary response vectors: \vec{S} which is a Signature vector, and \vec{RS} which is a Robust Signature vector.

For generation of signatures robust to additive noise, such as White-Gaussian-Noise, scratch, etc., but not robust to distortions, such as crop, shift and rotation, etc., a core Ci={ni} (1≦i≦L) may consist of a single leaky integrate-to-threshold unit (LTU) node or more nodes. The node ni equations are:

$${V}_{i} = {\sum }_{j} {w}_{ij} {k}_{j}$$

$${n}_{i} = θ ( Vi - {Th}_{x} )$$

where, θ is a Heaviside step function; wᵢⱼ is a coupling node unit (CNU) between node i and image component j (for example, grayscale value of a certain pixel j); kj is an image component ‘j’ (for example, grayscale value of a certain pixel j); Thₓ is a constant Threshold value, where ‘x’ is ‘S’ for Signature and ‘RS’ for Robust Signature; and Vi is a Coupling Node Value.

The Threshold values Thₓ are set differently for Signature generation and for Robust Signature generation. For example, for a certain distribution of Vi values (for the set of nodes), the thresholds for Signature (Th_{S}) and Robust Signature (Th_{RS}) are set apart, after optimization, according to at least one or more of the following criteria:

1: For: Vᵢ>Th_{RS}

1−p(V>Th_{S})−1−(1−ε)^{l}<<1

i.e., given that l nodes (cores) constitute a Robust Signature of a certain image I, the probability that not all of these I nodes will belong to the Signature of same, but noisy image, Ĩ is sufficiently low (according to a system's specified accuracy).

2: p(Vᵢ>Th_{RS})≈l/L

i.e., approximately l out of the total L nodes can be found to generate a Robust Signature according to the above definition.

3: Both Robust Signature and Signature are generated for certain frame i.

It should be understood that the generation of a signature is unidirectional, and typically yields lossless compression, where the characteristics of the compressed data are maintained but the uncompressed data cannot be reconstructed. Therefore, a signature can be used for the purpose of comparison to another signature without the need of comparison to the original data. The detailed description of the Signature generation can be found in U.S. Pat. Nos. 8,326,775 and 8,312,031, assigned to the common assignee, which are hereby incorporated by reference for all the useful information they contain.

A Computational Core generation is a process of definition, selection, and tuning of the parameters of the cores for a certain realization in a specific system and application. The process is based on several design considerations, such as:

(a) The Cores should be designed so as to obtain maximal independence, i.e., the projection from a signal space should generate a maximal pair-wise distance between any two cores' projections into a high-dimensional space.

(b) The Cores should be optimally designed for the type of signals, i.e., the Cores should be maximally sensitive to the spatio-temporal structure of the injected signal, for example, and in particular, sensitive to local correlations in time and space. Thus, in some cases a core represents a dynamic system, such as in state space, phase space, edge of chaos, etc., which is uniquely used herein to exploit their maximal computational power.

(c) The Cores should be optimally designed with regard to invariance to a set of signal distortions, of interest in relevant applications.

A detailed description of the Computational Core generation and the process for configuring such cores is discussed in more detail in the above-referenced U.S. Pat. No. 8,655,801.

FIG. 5 is an example block diagram illustrating the clustering system 130 according to an embodiment. The clustering system 130 includes a processing circuitry 510 coupled to a memory 520, a storage 530, and a network interface 540. In an embodiment, the components of the clustering system 130 may be communicatively connected via a bus 550.

The processing circuitry 510 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), general-purpose microprocessors, microcontrollers, digital signal processors (DSPs), and the like, or any other hardware logic components that can perform calculations or other manipulations of information. In an embodiment, the processing circuitry 510 may be realized as an array of at least partially statistically independent computational cores. The properties of each computational core are set independently of those of each other core, as described further herein above.

The memory 520 may be volatile (e.g., RAM, etc.), non-volatile (e.g., ROM, flash memory, etc.), or a combination thereof. In one configuration, computer readable instructions to implement one or more embodiments disclosed herein may be stored in the storage 530.

In another embodiment, the memory 520 is configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 510, cause the processing circuitry 510 to perform the various processes described herein. Specifically, the instructions, when executed, cause the processing circuitry 510 to perform clustering of multimedia content elements as described herein.

In an embodiment, the memory 520 includes a memory portion 525 including a plurality of compatibility engines. Each compatibility engine is configured to analyze signatures for multimedia content elements to determine a compatibility score for each associated cluster with respect to an input multimedia content element. Specifically, each compatibility engine may be configured to compare the multimedia content element signatures to signatures of clusters associated with the engine, where the compatibility engine is configured to determine the compatibility score based on the comparison.

The storage 530 may be magnetic storage, optical storage, and the like, and may be realized, for example, as flash memory or other memory technology, CD-ROM, Digital Versatile Disks (DVDs), or any other medium which can be used to store the desired information.

The network interface 540 allows the clustering system 130 to communicate with the signature generator system 140 for the purpose of, for example, sending multimedia content elements, receiving signatures, and the like. Additionally, the network interface 540 allows the clustering system 130 to communicate with the user device 110 in order to obtain multimedia content elements to be clustered.

It should be understood that the embodiments described herein are not limited to the specific architecture illustrated in FIG. 5, and other architectures may be equally used without departing from the scope of the disclosed embodiments. In particular, the clustering system 130 may further include a signature generator system configured to generate signatures as described herein without departing from the scope of the disclosed embodiments. Also, the clustering system 130 may be implemented as a user device (e.g., the user device 110, FIG. 1) having installed thereon an app (e.g., the app 115, FIG. 1). The app may be configured to perform the compatibility-based clustering process as described herein.

FIG. 6 is an example simulation 600 showing compatibility engines that may be utilized to cluster input multimedia content elements. The simulation 600 shows a facial recognition engine 610, a metadata engine 620, an objects engine 630, and a living things engine 640. Each of the engines 610 through 640 is associated with at least one multimedia content element cluster. Each engine is configured to analyze signatures of input multimedia content elements and to determine, based on the analysis, a compatibility score for each cluster.

In the example simulation 600, the facial recognition engine 610 is configured with signatures of clusters of multimedia content elements showing faces and various facial features (e.g., eyes, nose, mouth, etc.). A compatibility score generated by the facial recognition engine 610 may represent, for example, a certainty that an input multimedia content element shows a face or a portion of a face. As a non-limiting example, signatures generated for an input image showing a winking eye may be compared to signatures of a face cluster, of an eye cluster, of a nose cluster and of a mouth cluster. Compatibility scores for the clusters may be, on a scale of 0 to 1, 0.6 for the face cluster, 0.9 for the eye cluster, 0.2 for the nose cluster, and 0.1 for the mouth cluster, based on matching signatures representing each cluster to the input multimedia content element signatures.

The metadata engine 620 is configured with signatures of clusters of multimedia content elements featuring information that may be included in metadata such as, but not limited to, multimedia content type (e.g., image, video, audio, etc.), geographical location of capture, size, time of capture, a device by which the input multimedia content element was captured, tags, and the like. A compatibility score generated by the metadata engine 620 may represent, for example, a certainty that an input multimedia content element features the respective type of metadata information represented by the cluster.

The objects engine 630 is configured with signatures of clusters of multimedia content elements showing non-living objects such as, but not limited to, vehicles, buildings, signs, electronics, toys, and the like. A compatibility score generated by the objects engine 630 may represent, for example, a certainty that an input multimedia content element features a particular kind of object.

The living things engine 640 is configured with signatures of clusters of multimedia content elements showing living organisms such as, but not limited to, humans, animals, plants, and the like. A compatibility score generated by the objects engine 640 may represent, for example, a certainty that an input multimedia content element features a particular kind of object.

Any of the engines 610, 620, 630, and 640 may be related in that the related engines share at least one common cluster. In the example simulation 600, the facial recognition engine 610 is related to the metadata engine 620 and to the living things engine 640. Further, the metadata engine 620 is related to the living things engine 640 and to the objects engine 630. Compatibility scores for each common cluster may be determined by aggregating compatibility scores for the cluster determined by each related engine sharing the common cluster. The following are examples of common clusters for each set of related engines:

The common cluster for the facial recognition engine 610 and the metadata engine 620 may be, for example, a cluster showing selfies that is associated with both of the engines 610 and 620.

The common cluster for the facial recognition engine 610 and the living things engine 640 may be, for example, a cluster showing human faces that is associated with both of the engines 610 and 640.

The common cluster for the metadata engine 620 and the living things engine 640 may be, for example, a cluster of multimedia content elements showing people having the tag “people” that is associated with both of the engines 620 and 640.

The common cluster for the metadata engine 620 and the objects engine 630 may be, for example, a cluster of multimedia content elements showing a building having the tag “Washington Monument” that is associated with both of the engines 620 and 630.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a step in a method is described as including “at least one of A, B, and C,” the step can include A alone; B alone; C alone; A and B in combination; B and C in combination; A and C in combination; or A, B, and C in combination.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for compatibility-based clustering of a multimedia content element, comprising:
generating at least one signature for the multimedia content element;
analyzing, by at least one compatibility engine, the generated at least one signature to determine at least one compatibility score, wherein each compatibility engine is associated with at least one cluster of multimedia content elements, wherein each compatibility engine is configured to compare the generated at least one signature to signatures of the associated at least one cluster, wherein the at least one compatibility score is determined based on the comparison;
determining, based on the at least one compatibility score, at least one compatible cluster; and
adding, to each compatible cluster, the multimedia content element.

2. The method of claim 1, wherein analyzing the generated at least one signature further comprises:
sending, to each compatibility engine, the at least one signature; and
receiving, from each compatibility engine, at least one of the at least one compatibility score.

3. The method of claim 1, wherein the at least one compatibility engine includes a plurality of compatibility engines, wherein at least one set of the plurality of compatibility engines is related, wherein each set of related compatibility engines includes at least two of the plurality of compatibility engines associated with a common cluster.

4. The method of claim 3, wherein analyzing the generated at least one signature further comprises:
aggregating the compatibility scores determined by the compatibility engines of each related set with respect to the common cluster of the related set to determine at least one aggregated compatibility score, wherein the determined at least one compatibility score includes the at least one aggregated compatibility score.

5. The method of claim 3, further comprising:
initializing at least one first compatibility engine of the plurality of compatibility engines to determine at least one first compatibility score, wherein at least one second compatibility engine of the plurality of compatibility engines is not initialized when at least one of the at least one first compatibility score is above at least one predetermined threshold.

6. The method of claim 1, wherein the compatibility score for each determined compatible cluster is above a predetermined threshold.

7. The method of claim 1, wherein each signature represents a concept, wherein each concept is a collection of signatures and metadata representing the concept.

8. The method of claim 1, wherein the at least one signature is generated via a signature generator system, wherein the signature generator system includes a plurality of at least partially statistically independent computational cores, wherein the properties of each computational core are set independently of properties of each other computational core.

9. A non-transitory computer readable medium having stored thereon instructions for causing a processing circuitry to execute a process, the process comprising:
generating at least one signature for the multimedia content element;
analyzing, by a plurality of compatibility engines, the generated signatures to determine a plurality of compatibility scores, wherein each compatibility engine is associated with at least one cluster of multimedia content elements, wherein each compatibility engine is configured to compare the generated signatures to signatures of the associated at least one cluster, wherein the compatibility scores are determined based on the comparison;
determining, based on the compatibility scores, at least one compatible multimedia content element cluster; and
adding, to each compatible cluster, the multimedia content element.

10. A system for compatibility-based clustering of multimedia content, comprising:
a processing circuitry; and
a memory, the memory containing instructions that, when executed by the processing circuitry, configure the system to:
generate at least one signature for the multimedia content element;
analyze, by a plurality of compatibility engines, the generated signatures to determine a plurality of compatibility scores, wherein each compatibility engine is associated with at least one cluster of multimedia content elements, wherein each compatibility engine is configured to compare the generated signatures to signatures of the associated at least one cluster, wherein the compatibility scores are determined based on the comparison;
determine, based on the compatibility scores, at least one compatible multimedia content element cluster; and
add, to each compatible cluster, the multimedia content element.

11. The system of claim 10, wherein the system is further configured to:
send, to each compatibility engine, the at least one signature; and
receive, from each compatibility engine, at least one of the at least one compatibility score.

12. The system of claim 10, wherein the at least one compatibility engine includes a plurality of compatibility engines, wherein at least one set of the plurality of compatibility engines is related, wherein each set of related compatibility engines includes at least two of the plurality of compatibility engines associated with a common cluster.

13. The system of claim 12, wherein the system is further configured to:
aggregate the compatibility scores determined by the compatibility engines of each related set with respect to the common cluster of the related set to determine at least one aggregated compatibility score, wherein the determined at least one compatibility score includes the at least one aggregated compatibility score.

14. The system of claim 12, wherein the system is further configured to:
initialize at least one first compatibility engine of the plurality of compatibility engines to determine at least one first compatibility score, wherein at least one second compatibility engine of the plurality of compatibility engines is not initialized when at least one of the at least one first compatibility score is above at least one predetermined threshold.

15. The system of claim 10, wherein the compatibility score for each determined compatible cluster is above a predetermined threshold.

16. The system of claim 10, wherein each signature represents a concept, wherein each concept is a collection of signatures and metadata representing the concept.

17. The system of claim 10, wherein the at least one signature is generated via a signature generator system, wherein the signature generator system includes a plurality of at least partially statistically independent computational cores, wherein the properties of each computational core are set independently of properties of each other computational core.

18. The system of claim 10, further comprising:
a signature generator system, wherein the at least one signature is generated via the signature generator system, wherein the signature generator system includes a plurality of at least partially statistically independent computational cores, wherein the properties of each computational core are set independently of properties of each other computational core.

19. The system of claim 10, wherein the memory further comprises:
a memory portion including the at least one engine.
